(19) United States
(12) Patent Application Publication
(10) Pub. No.: US 2021/0357729 A1
(43) Pub. Date: Nov. 18, 2021

(54) SYSTEM AND METHOD FOR EXPLAINING THE BEHAVIOR OF NEURAL NETWORKS

(71) Applicant: Carnegie Mellon University, Pittsburgh, PA (US)

(72) Inventors: Klas Leino, Pittsburgh, PA (US); Shayak Sen, Pittsburgh, PA (US); Anupam Datta, Palo Alto, CA (US); Matthew Fredrikson, Pittsburgh, PA (US)

(21) Appl. No.: 16/583,392

(22) Filed: Sep. 26, 2019

Related U.S. Application Data
(60) Provisional application No. 62/766,027, filed on Sep. 27, 2018.

(51) Int. Cl. G06N 3/04; G06F 17/18

(52) U.S. Cl. CPC G06N 3/0472; G06F 17/18; G06N 3/0481

(57) ABSTRACT

A computing machine accesses a set of intermediate artificial neurons in a deep neural network. The deep neural network is fully or partially trained. The computing machine computes, for each artificial neuron in the set of intermediate artificial neurons, an influence score based on an average gradient of an output quantity of interest with respect to the artificial neuron across a plurality of inputs weighted by a probability of each input. The computing machine provides an output associated with the computed influence scores.

### PRIORITY CLAIM

This application claims priority to U.S. Provisional Patent Application No. 62/766,027, filed on Sep. 27, 2018, entitled “SYSTEM AND METHOD FOR EXPLAINING THE BEHAVIOR OF NEURAL NETWORKS,” the entire content of which is incorporated herein by reference.

### GOVERNMENT RIGHTS

This invention was made with government support under CNS 1704845 awarded by the National Science Foundation and FA9550-17-1-0600 awarded by the United States Air Force. The government has certain rights in this invention.

### TECHNICAL FIELD

Embodiments pertain to computer architectures for machine learning. Some embodiments relate to artificial neural networks. Some embodiments relate to a system and method for explaining the behavior of artificial neural networks.

### BACKGROUND

In the last decade, neural networks have become more and more common. Artificial neural networks are sometimes used to make decisions. For example, in consumer banking, an artificial neural network may be used to make a preliminary decision to approve or disapprove a customer for a loan. In some schemes, the artificial neural network operates as a black box, providing an output of “approve” or “disapprove,” without any explanation. However, this may cause problems as, under some legal or best practice regimes, consumer banks are encouraged to provide the customer with reason(s) why his/her loan application was rejected and/or to prove that certain types of discrimination (e.g., race, religion, nationality, gender, and the like) were not used in making the decision on the loan application. As the foregoing illustrates, techniques for explaining the behavior of artificial neural networks may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a flow chart of a method for identifying the artificial neurons that are most influential to the behavior of an artificial neural network and generating a new artificial neural network with those artificial neurons, in accordance with some embodiments.

FIG. 7 illustrates an example image of a sedan and a portion of the image that was most relevant to a neural network in identifying the image as a sedan, rather than a pickup truck, in accordance with some embodiments.

FIG. 8 illustrates an example of slicing a neural network, in accordance with some embodiments.

FIG. 9 illustrates an example computing machine for explaining the behavior of an artificial neural network, in accordance with some embodiments.

### SUMMARY

The present disclosure generally relates to machines configured to provide artificial neural networks, including computerized variants of such special-purpose machines and improvements to such variants. In particular, the present disclosure addresses machine-implemented techniques for explaining the behavior of an artificial neural network.

According to some aspects, a machine-readable medium stores instructions which, when executed by one or more computing machines, cause the one or more computing machines to perform operations. The operations include accessing a set of intermediate artificial neurons in a deep neural network, wherein the deep neural network is fully or partially trained. The operations include computing, for each artificial neuron in the set of intermediate artificial neurons, an influence score based on an average gradient of an output quantity of interest with respect to the artificial neuron across a plurality of inputs weighted by a probability of each input. The operations include providing an output associated with the computed influence scores. The machine-readable medium may be a non-transitory medium.

According to some aspects, a machine-readable medium stores instructions which, when executed by one or more computing machines, cause the one or more computing machines to perform operations. The operations include accessing a set of intermediate artificial neurons in a deep neural network, wherein the deep neural network is fully or partially trained. The operations include computing, for each artificial neuron in the set of intermediate artificial neurons, an influence score, wherein the influence score measures an influence of the artificial neuron on an output quantity of interest for a set of inputs of the deep neural network. The operations include identifying, from the artificial neurons in the set of intermediate artificial neurons, a first subset of artificial neurons and a second subset of artificial neurons, wherein, for each artificial neuron in the first subset, the influence score exceeds a threshold value, and wherein, for each artificial neuron in the second subset, the influence score does not exceed the threshold value. The operations include generating a new artificial neural network comprising the first subset of artificial neurons and lacking at least a portion of the second subset of artificial neurons. The operations include providing an output representing the new artificial neural network. The machine-readable medium may be a non-transitory medium.

Other aspects include a method to perform the above operations, and a system including processing circuitry and memory, the memory storing instructions which, when executed by the processing circuitry, cause the processing circuitry to perform the above operations.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, techniques for explaining the behavior of artificial neural networks may be desirable. Such techniques may be useful in multiple contexts. For example, in the consumer banking context, the techniques may allow a bank to explain why the artificial neural network denied a loan to a customer, and to prove that the loan denial was not due to protected class discrimination. In the medical context, the techniques may provide insight into a diagnosis made by an artificial neural network, allowing a medical professional to verify the diagnosis and to explain it to the patient. In the image processing context, if the artificial neural network makes a mistake (e.g., classifies an image of a sedan as a pickup truck, rather than a sedan), the techniques may provide insight into why the mistake was made, to allow a programmer to modify the artificial neural network and/or to provide additional training data so that the mistake is less likely to be repeated in the future.

In some embodiments, an explanation engine accesses a set of intermediate artificial neurons in a deep neural network (DNN). The DNN is fully or partially trained. The explanation engine computes, for each artificial neuron in the set of intermediate artificial neurons, an influence score. The influence score measures an influence of the artificial neuron on an output quantity of interest for a set of inputs of the deep neural network. In some implementations, the influence score is based on an average gradient of an output quantity of interest with respect to the artificial neuron across a plurality of inputs weighted by a probability of each input. The explanation engine provides an output associated with the computed influence scores.

In some implementations, a building engine identifies, from the artificial neurons in the set of intermediate artificial neurons, a first subset of artificial neurons and a second subset of artificial neurons. For each artificial neuron in the first subset, the influence score exceeds a threshold value. For each artificial neuron in the second subset, the influence score does not exceed the threshold value. The building engine generates a new artificial neural network (ANN) comprising the first subset of artificial neurons and lacking at least a portion of the second subset of artificial neurons. The building engine provides an output representing the new ANN.

In some cases, the new ANN is used for the same purpose as the DNN. In some cases, the new ANN may be more effective and/or more accurate than the DNN. In some cases, the DNN may be more effective and/or more accurate than the new ANN.

As used herein, the terms “ANN” and “DNN” encompass their plain and ordinary meaning. According to some examples, artificial neural networks (ANN) are computing systems that are inspired by, but not identical to, biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. In some cases, they do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it. The artificial neurons may be arranged into layers. A first layer processes the input, a last layer provides the output. Intermediate layers, called “hidden layers” provide intermediate processing for computing the output from the input. An ANN that includes at least one hidden layer is called a deep neural network (DNN).

The technology disclosed herein uses various engines, each of which is constructed, programmed, configured, or otherwise adapted, to carry out a function or set of functions. The term “engine” as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

As used herein, the term “computing machine” may include a single computing machine or multiple computing machines. A computing machine may include any device or combination of devices that includes processing circuitry and memory. The processing circuitry and the memory may reside in the same device or in different devices.

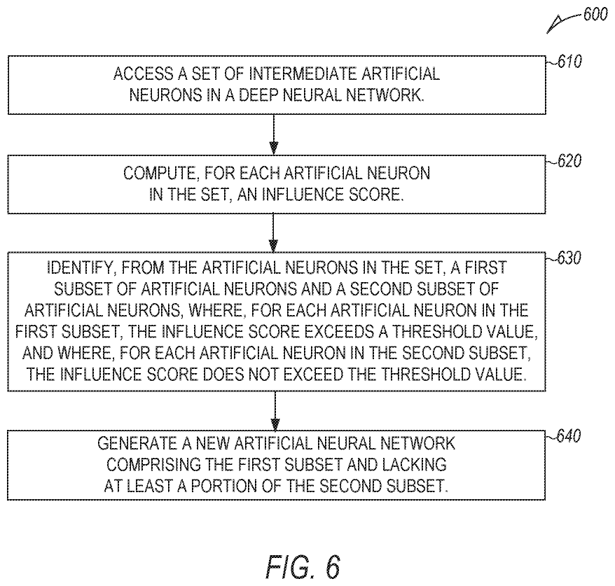

Throughout this document, some method(s) (e.g., in FIG. 6) are described as being implemented serially and in a given order. However, unless explicitly stated otherwise, the operations of the method(s) may be performed in any order. In some cases, two or more operations of the method(s) may be performed in parallel using any known parallel processing techniques. In some cases, some of the operation(s) may be skipped and/or replaced with other operations. Furthermore, skilled persons in the relevant art may recognize other operation(s) that may be performed in conjunction with the operation(s) of the method(s) disclosed herein.

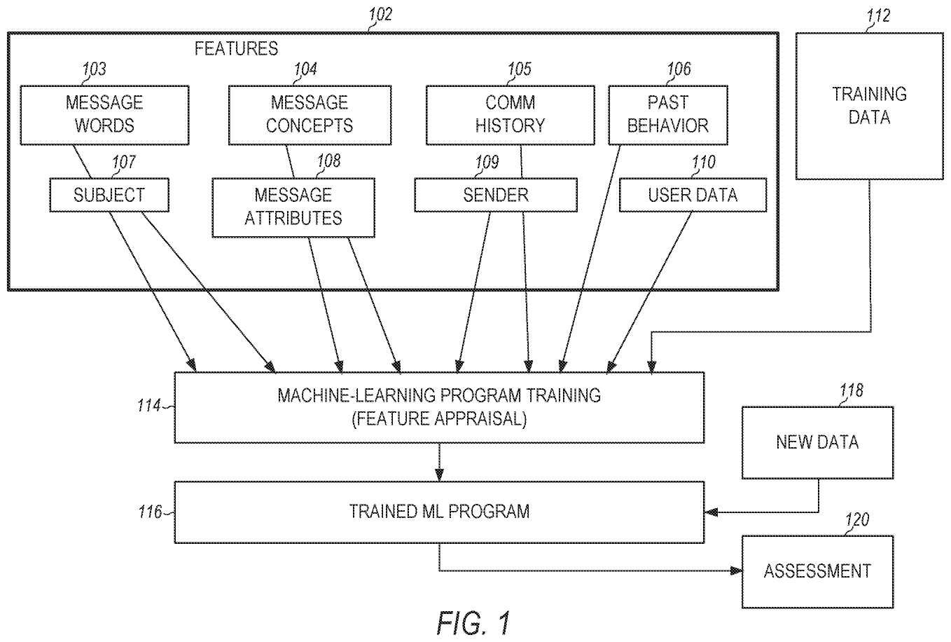

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, the machine-learning program 116 may be asked to count the number of sedans and pickup trucks in a parking lot between 10:00 and 11:00. The machine-learning program 116 determines the required image quality to extract the information that is needed. The machine-learning program 116 determines if a target model exists for sedans and pickup trucks. The machine-learning program 116 locates images having the required image quality to extract the information that is needed. If such images do not exist for the given time and geographic location parameters, the machine-learning program 116 requests collection of such images for the given time and geographic location parameters. Upon receiving the requested or located images, the machine-learning program 116 pushes the images to the appropriate model.

Machine learning techniques train models to accurately make predictions on data fed into the models. During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that is has not been trained on. In a second example, a false positive rate or false negative rate may be used to evaluate the models after finalization. In a third example, a delineation between data clusterings is used to select a model that produces the clearest bounds for its clusters of data.

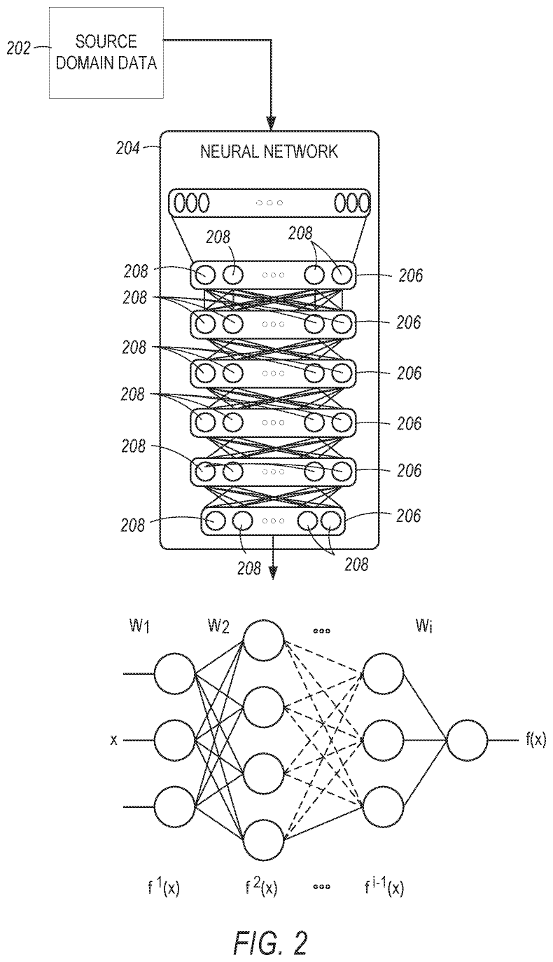

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at ƒ¹(x), ƒ²(x), . . . , ƒ⁻¹(x), until finally the output ƒ(x) is computed.

In some example embodiments, the neural network 204 (e.g., deep learning, deep convolutional, or recurrent neural network) comprises a series of neurons 208. A neuron 208 is an architectural element used in data processing and artificial intelligence, particularly machine learning on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized in various configurations of neural networks to provide interactions and relationship learning modeling for how each of the frames in an utterance are related to one another.

For example, a neural network node serving as a neuron includes several gates to handle input vectors (e.g., sections of an image), a memory cell, and an output vector (e.g., contextual representation). The input gate and output gate control the information flowing into and out of the memory cell, respectively. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., patterns in an image). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

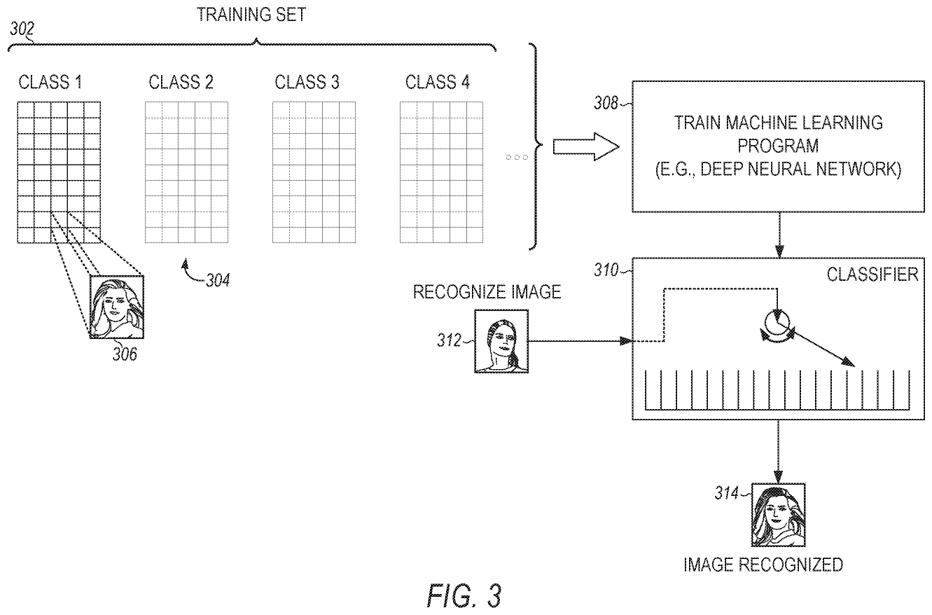

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Donald Trump, one class corresponds to Barack Obama, one class corresponds to George W. Bush, etc.). At block 308 the machine learning program is trained, for example, using a deep neural network. At block 310, the trained classifier, generated by the training of block 308, recognizes an image 312, and at block 314 the image is recognized. For example, if the image 312 is a photograph of Bill Clinton, the classifier recognizes the image as corresponding to Bill Clinton at block 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

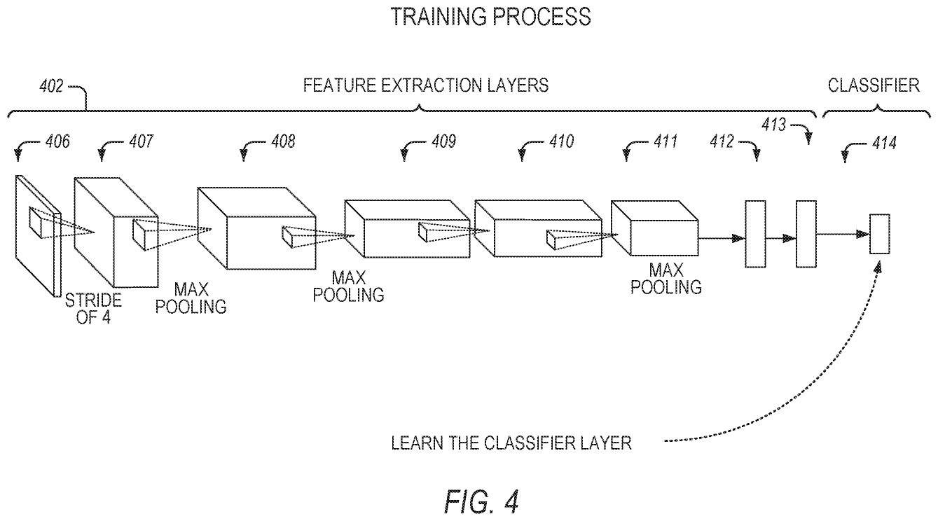

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as be reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

FIG. 4 is described in conjunction with a “stride of 4.” However, it should be noted that any other positive integer stride value may be used. Also, FIG. 4 describes some but not all examples of stages of neural network processing. Some aspects of the technology disclosed herein may implement one or more of: convolution, skip connections, activation, batch normalization, dropout, and the predictive function. Skip connections include shortcuts to jump over some layers (e.g., layer m provides input directly to layer m+2). An activation is a minimum amount of input that causes an artificial neuron to “fire” an output. Batch normalization is a technique for training very deep neural networks that standardizes the inputs to a layer for each mini-batch. This has the effect of stabilizing the learning process and dramatically reducing the number of training epochs required to train deep networks. Dropout sets the output of some neurons to zero in order to prevent a neural network from overfitting. The idea of dropout is to randomly drop units (along with their connections) from the artificial neural network during training. This prevents the units from co-adapting too much.

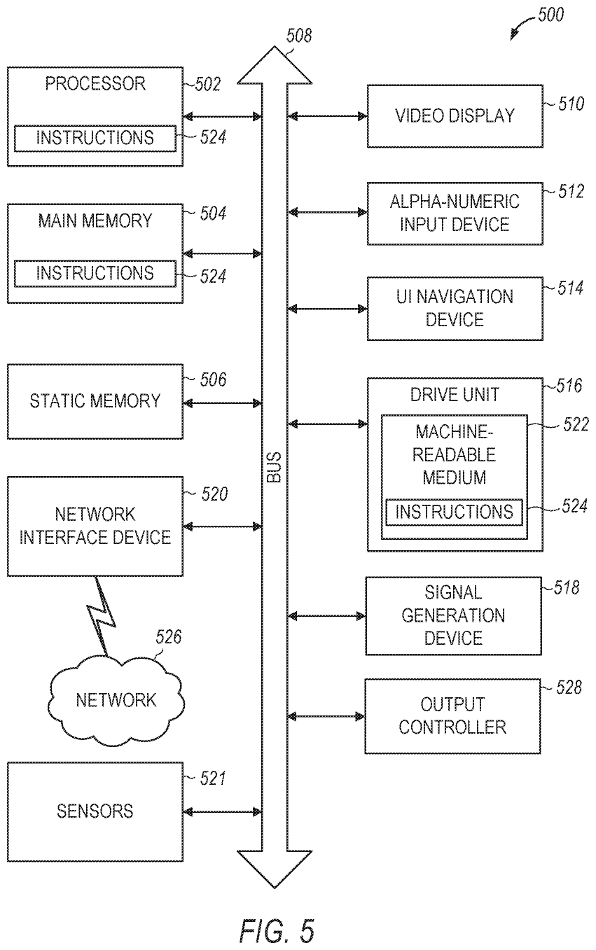

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

FIG. 6 is a flow chart of a method 600 for identifying the artificial neurons that are most influential to the behavior of an artificial neural network and generating a new artificial neural network with those artificial neurons, in accordance with some embodiments.

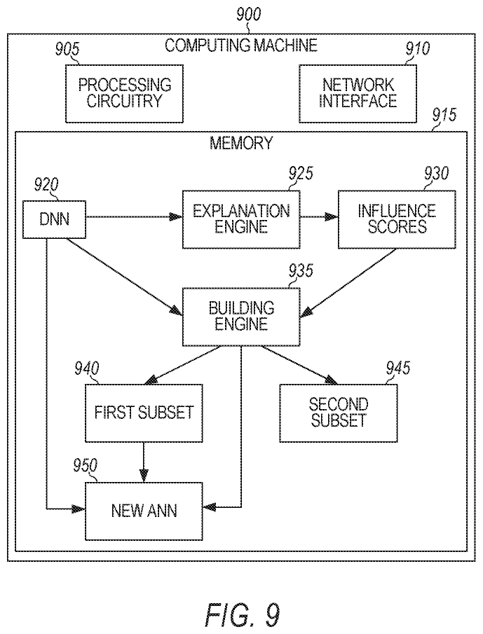

At operation 610, a computing machine (e.g., the computing machine 900 discussed below in conjunction with FIG. 9) accesses a set of intermediate artificial neurons in a deep neural network (DNN). The deep neural network may be fully or partially trained.

At operation 620, the computing machine computes, for each artificial neuron in the set of intermediate artificial neurons, an influence score. The influence score measures an influence of the artificial neuron on an output quantity of interest for a set of inputs of the deep neural network. In some cases, the influence score is based on an average gradient of an output quantity of interest with respect to the artificial neuron across a plurality of inputs weighted by a probability of each input. The computing machine may provide an output associated with the computed influence scores. For example, the output may be transmitted via a network or transmitted to a display port for display.

In some embodiments, the computing machine determines, based on at least a subset of the computed influence scores, an influence-directed explanation why a given set of inputs to the deep neural network corresponds to the output quantity of interest. The output associated with the computed influence scores comprises the influence-directed explanation. The influence-directed explanation may include a portion of the input responsible for the output quantity of interest.

In some cases, the computing machine determines (e.g., based on a user input or based on input from other artificial intelligence) that, for the given set of inputs to the deep neural network, the output quantity of interest comprises an error. In response to the error and based on the influence-directed explanation, the computing machine (e.g., using another artificial intelligence or in response to user input) adjusts the deep neural network or provides additional training data or different preprocessing steps to the deep neural network.

At operation 630, the computing machine identifies, from the artificial neurons in the set of intermediate artificial neurons, a first subset of artificial neurons and a second subset of artificial neurons. For each artificial neuron in the first subset, the influence score exceeds a threshold value. For each artificial neuron in the second subset, the influence score does not exceed the threshold value.

At operation 640, the computing machine generates a new artificial neural network (ANN) comprising the first subset of artificial neurons and lacking at least a portion of the second subset of artificial neurons (e.g., the portion of the second subset that is not needed). In some cases, the computing machine provides an output representing the new artificial neural network. For example, the output may be transmitted via a network or transmitted to a display port for display.

In some cases, the new ANN lacks a portion of the second subset of artificial neurons. In some cases, the new ANN lacks each and every artificial neuron in the second subset of artificial neurons.

In some implementations, the new ANN is used for the same purpose as the DNN. In some cases, the new ANN may be more effective and/or more accurate than the DNN. In some embodiments, the DNN may be more effective and/or more accurate than the new ANN. In some examples, the computing machine uses the new ANN to solve a same problem as the DNN. In some cases, the new ANN is much smaller (has fewer artificial neurons) than the DNN. For example, the DNN may have 4,000 neurons and the new ANN may have 400 neurons. The new ANN may be below a predefined percentage (e.g., 5%, 15%, 25%, etc.) of the size (in artificial neurons) of the DNN.

FIG. 7 illustrates an example image 700 of a sedan and a portion 710 of the image that was most relevant to a neural network in identifying the image as a sedan, rather than a pickup truck, in accordance with some embodiments. As illustrated in FIG. 7, the portion includes the trunk, which has a different shape in a sedan than in a pickup truck. The portion 710 may be the “influence-directed explanation” for why the featured vehicle is a sedan rather than a pickup truck, as described in conjunction with FIG. 6.

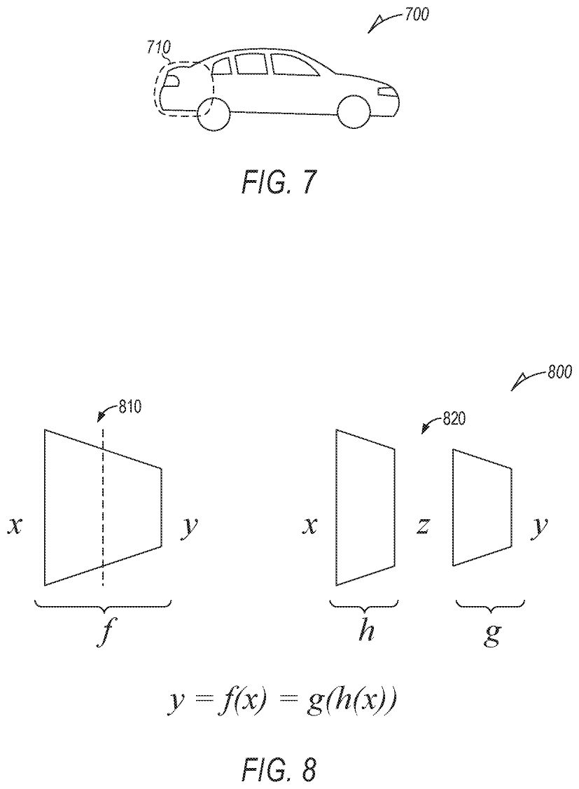

FIG. 8 is an example diagram 800 of slicing a neural network, in accordance with some embodiments.

In some examples, the set of intermediate artificial neurons described above in conjunction with FIG. 6 is an intermediate layer in the DNN. As shown at block 810, the output quantity of interest is represented as y=f(x)=g(h(x)), where x is the input and f, g, and h are mathematical functions. As shown at block 820, the intermediate layer is z=h(x). It should be noted that y=f(x)=g(h(x))=g(z). The intermediate layer z of block 820 corresponds to the dashed line of block 810.

In some embodiments, the computing machine computes the influence score for a given artificial neuron zj in the intermediate layer using Equation 1.

$${{χ}_{j}^{s} ( f , P ) = {\int }_{χ} \frac{\partial g}{\partial {z}_{j}} \vert}_{h ( x )} P ( x ) dx \qquad Equation 1$$

In Equation 1, χ is the influence score, and P(x) is the probability of the input x.

FIG. 9 illustrates an example computing machine 900 for explaining the behavior of an artificial neural network, in accordance with some embodiments. A single computing machine 900 is illustrated in FIG. 9. However, in some embodiments, the functionality of the computing machine 900 may be distributed across multiple computing machines working in concert and connected to one another via wired connection(s), wireless connection(s) or network(s).

As shown, the computing machine 900 includes processing circuitry 905, a network interface 910, and memory 915. The processing circuitry 905 may include any processing hardware, such as a central processing unit (CPU), a graphics processing unit (GPU), and the like. The network interface 910 may include one or more network interface cards (NICs) to allow the computing machine 900 to communicate over network(s). The memory 915 may include a cache unit and/or a storage unit. The memory 915 stores data and/or instructions, which may be encoded using software, hardware or a combination of software and hardware. As shown, the memory 915 includes a DNN 920, an explanation engine 925, a first subset 930, a second subset 935, a building engine 940, and a new ANN 945.

The DNN 920 includes a plurality of artificial neurons and may be fully or partially trained. The DNN 920 may be any DNN, for example, a DNN trained to recognize whether visual data includes a sedan or a pickup truck.

The explanation engine 925 accesses a set of intermediate artificial neurons in the DNN 920. The explanation engine 925 computes, for each artificial neuron in the set of intermediate artificial neurons, an influence score 930. The influence score 930 measures an influence of the artificial neuron on an output quantity of interest for a set of inputs of the DNN 920. In some implementations, the influence score 930 is based on an average gradient of an output quantity of interest with respect to the artificial neuron across a plurality of inputs weighted by a probability of each input. The explanation engine 925 provides an output associated with the computed influence scores 930.

In some implementations, a building engine 935 identifies, from the artificial neurons in the set of intermediate artificial neurons, a first subset 940 of artificial neurons and a second subset 945 of artificial neurons. For each artificial neuron in the first subset 940, the influence score 930 exceeds a threshold value. For each artificial neuron in the second subset 945, the influence score 930 does not exceed the threshold value. The building engine 935 generates a new ANN 950 comprising the first subset 940 of artificial neurons and lacking at least a portion of the second subset 945 of artificial neurons. The building engine 935 provides an output representing the new ANN 950.

In some cases, the new ANN 950 is used for the same purpose as the DNN 920, for example, to recognize whether visual data includes a sedan or a pickup truck. In some cases, the new ANN 950 may be more effective and/or more accurate than the DNN 920. In some cases, the DNN 920 may be more effective and/or more accurate than the new ANN 950.

The problem of explaining a class of behavioral properties of deep neural networks, with a focus on convolutional neural networks, has received significant attention in recent years with the rise of deep networks and associated concerns about their opacity. Explanations that provide insight into reasons behind incorrect network behavior play an important role in mitigating opacity. Some schemes for explaining deep convolutional network behavior are based on mapping model's prediction outputs back to relevant regions in an input image. This is accomplished in various ways, such as by visualizing gradients, backpropagation, or fitting simpler interpretable models around a test point to predict relevant input regions. These approaches capture input influence, but because these approaches relate instance-specific features to instance-specific predictions, the explanations that they produce do not generalize beyond a single test point.

An orthogonal approach is to visualize the features learned by networks by identifying input instances that maximally activate an internal neuron, by either optimizing the activation in the input space, or searching for instances in a dataset. Importantly, this type of explanation gives insight into the higher-level concepts learnt by the network, and naturally generalizes across instances and classes. However, this approach does not relate these higher-level concepts to predictions that they cause. Indeed, examining activations alone is not sufficient to do so.

Artificial neural network systems are widely used in a number of application settings, including but not limited to diagnosis of radiology images, identification of oil and natural gas prospects, and self-driving cars. In each of these applications, a failure to understand why the system behaves the way it does impedes the deployment of these advanced systems.

Some techniques described herein relate to a system and method for explaining the outcomes of deep neural network systems by examining their internal functioning and identifying the most important internal concepts identified by the artificial neural network system. Non-limiting examples of the system can be employed towards a number of tasks including but not limited to enhancing trust in network's functioning, diagnosing faults, and improving predictive performance in a number of domains where such artificial neural networks are used including but not limited to diagnosis of radiology images, identification of oil and natural gas prospects, and self-driving cars. The system analyzes an artificial neural network to identify the most influential internal components and subsequently provide an interpretation for them. These interpretations can: (1) identify influential concepts learned by an artificial neural network that generalize across instances (for example, artificial neural networks may learn that in radiology images of eyes particular lesions are highly predictive of diabetic retinopathy); (2) help extract the essence of what the network learned about a class of inputs (some aspects identify a small set of internal components that distinguish a particular class of inputs from the rest); (3) provide a comparative explanation of why an instance was classified one way versus the other; and (4) assist in understanding misclassifications by examining internal influences. To this end, one can verify that concepts that are known to be important are actually regarded as important by the network.

As described above, explaining a class of behavioral properties of a deep neural network is presently a technical challenge. One method described herein approaches the problem of explaining a rich class of behavioral properties of deep neural networks by using an influence-directed explanations approach. This approach peers inside the network to identify neurons with high influence on the property and distribution of interest using an axiomatically justified influence measure, and then providing an interpretation for the concepts the neuron represents. Included in some aspects of this approach is a distributional influence measure that identifies which artificial neurons are most influential in determining the model's behavior on a given distribution of instances. FIG. 7 illustrates an example image 700 which may be processed through a DNN to determine whether it illustrates a sedan or a pickup truck. The region 710 indicates the artificial neurons that are responsible for classifying this image as a sedan rather than as a pickup truck. The results coincide with an intuitive understanding of the distinction between the classes of “sedan” and “pickup truck”—the depicted interpretation highlights the portion of the image depicting the car's trunk.

Distributional influence is an axiomatically justified family of measures of influence. Distributional influence is parameterized by a slice of the network (e.g. a particular layer), a quantity of interest, and a distribution of interest. The measure is the average partial derivative of the quantity of interest over the distribution of interest at the slice. The description of the measure, its parameters, and the justification for this family measures is detailed below.

The slice parameter exposes the internals of a network, and allows one to compute influence with respect to intermediate artificial neurons, a significant departure from prior work. Importantly, as opposed to input pixels, as internal artificial neurons can represent higher-level concepts, influential internal artificial neurons allow explanations to be more general rather than being specific to single instances.

The distribution and quantity of interest together capture aspects of artificial neural network behavior. Examples of distributions of interest are: (i) a single instance (influence measure just reduces to the gradient at the point) (ii) the distribution of ‘cat’ images (e.g., in an ANN trained to classify images of cats and/or dogs), or (iii) the overall distribution of images. While the first distribution of interest focuses on why a single instance was classified a particular way, the second explains the essence of a class, and the third identifies generally influential artificial neurons over the entire population. A fourth instance is the uniform distribution on the line segment of scaled instances between an instance and a baseline, which yields a measure called Integrated Gradients. Examples of quantities of interest are: outcome towards the ‘cat’ class (i.e., the network score for the cat class) or comparative outcome towards ‘cat’ versus ‘dog’ (i.e., the difference in the network scores for cat and dog classes). The first quantity of interest answers the question of why a particular input was classified as a cat, whereas the second can be helpful in understanding how the network distinguishes ‘cat’ instances from ‘dog’ instances.

Quantities of interest of networks are represented as continuous and differentiable functions f from X→R, where X⊆Rⁿ, and n is the number of inputs to f. A distributional influence measure, denoted by xᵢ(f, P), measures the influence of an input i for a quantity of interest f, and a distribution of interest P, where P is a distribution over X.

A particular layer in the network can be viewed as a slice. More generally, a slice is any partitioning of the network into two parts that exposes its internals. Formally, a slices of a network f is a tuple of functions (g,h), such that h:X→Z, and g:Z→R, and f=gºh. The internal representation for an instance x is given by z=h(x). In the current setting, elements of z can be viewed as the activations of neurons at a particular layer.

Definition 1. The influence of an element j in the internal representation defined by s=<g, h> is given by

$${{χ}_{j}^{s} ( f , P ) = {\int }_{χ} \frac{\partial g}{\partial {z}_{j}} \vert}_{h ( x )} P ( x ) dx \qquad Equation 1$$

The influence measure defined above is parameterized by a distribution of interest P (Equation 1) over which the measure is taken. By selecting P to be a point mass, the resulting measurements characterize the importance of features or components for the model's behavior on a single instance. Any meaningful interpretation of these measurements can refer only to that instance, and thus reflect specific features and concepts that may not generalize across a class. Defining the distribution of interest with support over a larger set of instances will yield explanations that capture the factors common to network behaviors across the corresponding population of instances. These explanations capture the “essence” of what the network learned about that population, and can be used to identify the concepts that are most relevant to the network's behavior on it.

It is sometimes the case that relatively few units are highly influential towards a particular class. In such cases, refer to this as the “essence” of the class, as the network's behavior on these classes can be understood by focusing on these units. To validate this claim, these units can be isolated from the rest of the model to extract a classifier that is more proficient at distinguishing class instances from the rest of the data distribution than the original model. To this end, a technique for compressing models using influence measurements to yield class-specific “expert” models that demonstrate the essence of that class learned by the model is introduced.

Given a model, f, with softmax output, and slice, (g,h), where g:Z→Y, let MₕϵZ be a 0-1 vector. Intuitively, Mₕ masks the set of units at layer h that we wish to retain, and so is 1 at all locations corresponding to such units and 0 everywhere else. Then the slice compression f_{M}_{ₕ}(X)=g(h(X)*Mₕ) corresponds to the original model after discarding all units at h not selected by Mₕ. Given a model f, a binary classifier fⁱ for class Lᵢ (corresponding to softmax output i) may be obtained by projecting the softmax output at i, in addition to the sum of all other outputs: fⁱ=(f|ᵢ, Σ_{j/=i} f|ⱼ), where f|ᵢ is the projection of the model's softmax output to its i^{th} coordinate.

Class-specific experts—For the sake of this discussion, we define a class-wise expert for Lᵢ to be a slice compression f_{M}_{ₕ} whose corresponding binary classifier fⁱ achieves Mₕ better recall on Lᵢ than the binary classifier fⁱ obtained by f, while also achieving approximately the same recall. We demonstrate that the influence measurements taken at slice <g, h> over a distribution of interest, Pᵢ, conditioned on class Lᵢ yields an efficient heuristic for extracting experts from large networks.

In particular, Mₕ can be computed by measuring the slice influence (Equation 1) over Pᵢ using the quantity of interest g|ᵢ. Given parameters α and β, select α units at layer h with the largest positive influence, and β units with the greatest negative influence (i.e., greatest magnitude among those with negative influence). Mₕ is then defined to be zero at all positions except those corresponding to these α+β units. In our experiments, concrete values are obtained for α and β by a parameter sweep, ultimately selecting those values that yield the best experts by the criteria defined above.

TABLE 1
Model compression recall for five randomly-selecled ImageNet classes.
Columns marked Orig. correspond to the original model, Act. to experts
computed using activation levels, and Infl. to experts computed using
influence measures. Precision in all cases was 1.0.

| Class | Orig. | Act. | Infl. |
|---|---|---|---|
| Chainsaw (491) | .14 | 0. | .71 |
| Bonnet (452) | .62 | 0. | .92 |
| Park Bench (703) | .52 | 0. | .71 |
| Sloth Bear (297) | .36 | 0. | .75 |
| Pelican (144) | .65 | 0. | .95 |

Table 1 shows the recall of experts found in this way for five randomly selected ImageNet classes, as well as the recall of the original model on each class and on experts computed using activations, rather than influence. Precision is not shown because in all cases it was 1.0. This shows that the top and bottom influential artificial neurons are sufficient to capture the concepts embodied in a particular layer that discriminate a given class from the others. Removing non-influential artificial neurons yields significantly higher recall than the baseline model, and moreover activation levels are not a meaningful and consistent indication of the relevance of an artificial neuron. In other words, measuring internal influence is an effective way to identify the concepts that the network learned in order to discriminate classes from each other.

The results discussed so far demonstrate that internal distributional influence measurements can be used to identify relevant concepts that generalize across instances, and distinguish between classes. The concepts identified in this way often represent input-space features that are interpretable by domain experts as important for correctly classifying instances, and can be identified as such even when it is not possible to interpret those concepts reliably in pixel space.

An Inception network may be trained to diagnose the severity of diabetic retinopathy in color retinal fundus images. Diabetic Retinopathy (DR) is a medical condition characterized by damage to the retina occurring due to diabetes. DR is classified on a scale from 1 to 5, with class 1 corresponding to the absence of symptoms and class 5 being the most severe presentation. In one dataset used to train the model, class-1 is the most common and the remaining classes distributed relatively evenly. Class-2, the least severe positive diagnosis, is characterized by the presence of visible microaneurysms only, with no other symptoms present on the fundus image that distinguish it from class-1. Due to their small size in the pixel space, validating that they have been identified by an influence measurement is challenging because it is not possible to visualize them well.

To address this challenge, a dataset was created to control for the presence of microaneurysm features that characterize class-2 instances. Specifically, all images with a minor Gaussian blur were pre-processed to remove the corresponding visual features, and trained a second model on the dataset generated by this intervention.

The model trained on the original dataset behaved as expected, and achieved a non-trivial recall of class-2 instances (approximately 15%). We were also able to extract an expert for each class from this model that improved on the recall of the original model, demonstrating that internal influence measures identified distinctive concepts in this case.

The model trained on the intervened dataset displayed classification behavior consistent with our expectation that applying small-radius Gaussian blur removes microaneurysm features. Namely, the intervened model classified none of the instances in the validation set as class-2, and instead classified 95% of the true class-2 instances as class-1. Moreover, when the same strategy was applied for extracting an expert for class-2, the model was unable to find a set of influential neurons that achieved better (i.e., non-zero) recall. This was the case even if the criteria for selecting experts were relaxed to allow for reduced precision.

To summarize, by controlling for the presence of an important concept in the source data, it may be possible to characterize the concept represented by internal units by testing for “disappearing experts” in retrained models.

The learned concepts identified by measuring influence on internal units are useful when explaining model behavior on individual instances.

As discussed above, computing the influence on a slice of the network (Equation 1) lets a machine determine how relevant neurons in intermediate layers are to a particular network behavior. In particular, given an image and the artificial neural network's prediction on that image, the influence measurements for a slice can reveal which features or concepts present in that image were relevant to the prediction.

As discussed above, computing the influence on a slice of the network (Equation 1) lets a machine determine how relevant artificial neurons in intermediate layers are to a particular network behavior. In particular, given an image and the network's prediction on that image, the influence measurements for a slice can reveal which features or concepts present in that image were relevant to the prediction.

Influential distributional concepts can also lead to insights about misclassification behavior on particular instances. Some visualizations were generated by measuring influence on a slice corresponding to the bottom-most fully-connected layer of a Diabetic Retinopathy (DR) model.

The justification of the family of measurements associated with the above mentioned Distributional Influence is done by defining a set of natural properties that an influence measure should satisfy, and proving a tight characterization of these measures. Addressed first is the case where the influence is measured with respect to inputs, i.e. when the slice is an identity function. Then, generalize this measure to general slices, and address the case where influence is measured with respect to internal artificial neurons.

First, characterize a measure xᵢ(f, P) that measures the influence of input i for a quantity of interest f, and distribution of interest P. The first axiom, linear agreement states that for linear systems, the coefficient of an input is its influence. Measuring influence in linear models is straight-forward since a unit change in an input corresponds to a change in the output given by the coefficient.

Axiom 1 (Linear Agreement). For linear models of the form f(x)=Σᵢαᵢxᵢ, χᵢ(f, P)=αᵢ.

The second axiom, distributional marginality states that gradients at points outside the support of the distribution of interest should not affect the influence of an input. This axiom ensures that the influence measure only depends on the behavior of the model on points within the manifold containing the input distribution.

Axiom 2 (Distributional marginality (DM)). If,

$${{P ( \frac{\partial {f}_{1}}{\partial {x}_{i}} \vert}_{X} = \frac{\partial {f}_{2}}{\partial {x}_{i}} \vert}_{X} ) = 1 ,$$

where X is the random variable over instances from χ, then χᵢ(f₁, P)=χᵢ(ƒ₂, P).

The third axiom, distribution linearity states that the influence measure is linear in the distribution of interest. This ensures that influence measures are properly weighted over the input space, i.e., influence on infrequent regions of the input space receive lesser weight in the influence measure as compared to more frequent regions.

Axiom 3 (Distribution linearity (DL)). For a family of distributions indexed by some aϵ [symbol] , P(x)= [symbol] g(a)Pₐ(x)da, then χᵢ(ƒ, P)= [symbol] g(a)χᵢ(ƒ, Pₐ)da.

It can be shown that the only influence measure that satisfies these three axioms is the weighted gradient of the input probability distribution.

Theorem 1. The only measure that satisfies linear agreement, distributional marginality and distribution linearity is given by

$${{χ}_{i} ( f , P ) = {\int }_{χ} \frac{\partial F}{\partial {x}_{i}} \vert}_{x} P ( x ) dx .$$

Next, we generalize the above measure of input influence to a measure that can be used to measure the influence of an internal neuron. Taking an axiomatic approach, with two natural invariance properties on the structure of the network.

The first axiom states that the influence measure is agnostic to how a network is sliced, as long as the neuron with respect to which influence is measured is unchanged. Below, the notation x-i refers to the vector x with element i removed.

Two slices s₁= [symbol] g₁, h₁ [symbol] and s₂= [symbol] g₂, h₂ [symbol] are j-equivalent if for all xϵX, and zjϵZⱼ,h₁(x)j=h₂(x)ⱼ, and g₁(h₁(x)−jzⱼ)=g₂(h₂(x)−ⱼzⱼ). Informally, two slices are j-equivalent as long as they have the same function for representing zⱼ, and the causal dependence of the outcome on z is identical.

Axiom 4 (Slice Invariance). For all j-equivalent slices s₁ and s₂, Xⱼ^{s}^{₁}(ƒ, P)=Xⱼ^{s}^{₂}(ƒ, P).

The second axiom equates the input influence of an input with the internal influence of a perfect predictor of that input. Essentially, this encodes a consistency requirement between inputs and internal neurons that if an internal neuron has exactly the same behavior as an input, then the internal neuron should have the same influence as the input.

Axiom 5 (Preprocessing). Consider hᵢ such that P(X₁=hᵢ(X₋₁))=1. Let s= [symbol] ƒ, h [symbol] , be such that h(x₋₁)=x₋ᵢhᵢ(x₋ᵢ1), which is a slice of ƒ^{l}(x₋ᵢ)=ƒ(x₋ᵢhᵢ(x₋ᵢ)), then Xᵢ(ƒ, P)=Xᵢ^{s}(ƒ^{l}, p).

It can now be shown that the only measure that satisfies these two properties is the one presented above.

Theorem 2. The only measure that satisfies slice invariance and preprocessing is Equation 1.

$${{χ}_{j}^{s} ( f , P ) = {\int }_{χ} \frac{\partial g}{\partial {z}_{j}} \vert}_{h ( x )} P ( x ) dx \qquad Equation 1$$

To prove the uniqueness theorems, first, characterize a measure Xᵢ(f, P) that measures the influence of input i for a quantity of interest f, and distribution of interest P. The first axiom, linear agreement states that for linear systems, the coefficient of an input is its influence. Measuring influence in linear models is straight-forward since a unit change in an input corresponds to a change in the output given by the coefficient.

Axiom 1 (Linear Agreement). For linear models of the form ƒ(x)=Σᵢαᵢxᵢ, χᵢ(ƒ, P)=αᵢ.

The second axiom, distributional marginality states that gradients at points outside the support of the distribution of interest should not affect the influence of an input. This axiom ensures that the influence measure only depends on the behavior of the model on points within the manifold containing the input distribution.

Axiom 2 (Distributional marginality (DM)). If,

$${{P ( \frac{\partial {f}_{1}}{\partial {x}_{i}} \vert}_{X} = \frac{\partial {f}_{2}}{\partial {x}_{i}} \vert}_{X} ) = 1 ,$$

where X is the random variable over instances from χ, then χᵢ(ƒ₁, P)=χᵢ(ƒ₂, P).

The third axiom, distribution linearity states that the influence measure is linear in the distribution of interest. This ensures that influence measures are properly weighted over the input space, i.e., influence on infrequent regions of the input space receive lesser weight in the influence measure as compared to more frequent regions.

Axiom 3 (Distribution linearity (DL)). For a family of distributions indexed some aϵ [symbol] , P(x)= [symbol] g(a)Pₐ(x)da, then χᵢ(ƒ, P)= [symbol] g(a)χᵢ(ƒ, Pₐ)da.
Theorem 1. The only measure that satisfies linear agreement, distributional marginality and distribution linearity is given

$${{χ}_{i} ( f , P ) = {\int }_{χ} \frac{\partial f}{\partial {x}_{i}} \vert}_{x} P ( x ) dx .$$

Proof Choose any function ƒ and Pₐ(x)=δ(x−a), where δ is the Dirac delta function on χ. Now, choose

$${{f}^{′} ( x ) = \frac{\partial f}{\partial {x}_{i}} \vert}_{a} {x}_{i} .$$

By linearity agreement, it must be the case that,

$${χ ( {f}^{′} , {P}_{a} ( X ) ) = \frac{\partial f}{\partial {x}_{i}} \vert}_{a} .$$

By distributional marginality, we therefore have that

$${{χ}_{i} ( f , {P}_{a} ) = {χ}_{i} ( {f}^{′} , {P}_{a} ) = \frac{\partial f}{\partial {x}_{i}} \vert}_{a} .$$

Any distribution P can be written as P(x)=∫_{χ} P(a)Pₐ(x)da. Therefore, by the distribution linearity axiom, we that

$${χ ( f , P ) = {\int }_{X} P ( a ) χ ( f , {P}_{a} ) da = {\int }_{χ} P ( a ) \frac{\partial f}{\partial {x}_{i}} \vert}_{a} da .$$

For Internal Influence:

Two slices s₁= [symbol] g₁, h₁ [symbol] and s₂= [symbol] g₂, h₂ [symbol] are j-equivalent if for all xϵχ, and zⱼϵ [symbol] ⱼ, h₁(x)ⱼ=h₂(x)ⱼ, and g₁(h₁(x)₋ⱼzⱼ)=g₂(h₂(x)₋ⱼzⱼ).

two slices s₁= [symbol] g₁, h₁ [symbol] and s₂= [symbol] g₂, h₂ [symbol] are j-equivalent if for all xϵX, and zⱼϵZⱼ, h₁(x)j=h₂(x)j, and g₁(h₁(x)−j zj)=g₂(h₂(x)−j zj).

Axiom 4 (Slice Invariance). For all j-equivalent slices s₁ and s₂, χⱼ^{s}^{₁}(ƒ, P)=χⱼ^{s}^{₂}(ƒ, P).
Axiom 5 (Preprocessing). Consider hᵢ such that P(Xᵢ=hᵢ(X₋ᵢ))=1. Let s= [symbol] ƒ, h [symbol] , be such that h(x₋ᵢ)=x₋ᵢhᵢ(x₋ᵢ), which is a slice of ƒ′(x₋ᵢ)=ƒ(x₋ᵢhᵢ(x₋ᵢ)), then χᵢ(ƒ, P)=χᵢ²(ƒ′, P).
Theorem 2. The only measure that satisfies slice invariance and preprocessing is Equation 1.

$${{χ}_{j}^{s} ( f , P ) = {\int }_{χ} \frac{\partial g}{\partial {z}_{j}} \vert}_{h ( x )} P ( x ) dx$$

Proof. Assume that two slices s₁= [symbol] g₁, h₁ [symbol] and s₂= [symbol] g₂, h₂ [symbol] are j-equivalent. Therefore, g₁(h₁(x)−_{jzj})=g₂(h₂(x)_{-jzj}). Taking partial derivatives with respect to zj, we have that:

$${{\frac{\partial {g}_{1}}{\partial {z}_{j}} \vert}_{{{h}_{1} ( x )}_{- j} {z}_{j}} = \frac{\partial {g}_{2}}{\partial {z}_{j}} \vert}_{{{h}_{2} ( x )}_{- j} {z}_{j}}$$

Now, since h₁(x)ⱼ=h₂(x)ⱼ, we have that

$${{\frac{\partial {g}_{1}}{\partial {z}_{j}} \vert}_{{h}_{1} ( x )} = \frac{\partial {g}_{2}}{\partial {z}_{j}} \vert}_{{h}_{2} ( x )}$$

Using these derivatives, we get that Xⱼ^{s}^{₁}(ƒ, P)=Xⱼ^{s}^{₂}(ƒ, P).

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A non-transitory machine-readable medium storing instructions which, when executed by one or more computing machines, cause the one or more computing machines to perform operations comprising:
accessing a set of intermediate artificial neurons in a deep neural network, wherein the deep neural network is fully or partially trained;
computing, for each artificial neuron in the set of intermediate artificial neurons, an influence score based on an average gradient of an output quantity of interest with respect to the artificial neuron across a plurality of inputs weighted by a probability of each input; and
providing an output associated with the computed influence scores.

2. The machine-readable medium of claim 1, wherein the influence score measures an influence of the artificial neuron on the output quantity of interest for a set of inputs of the deep neural network.

3. The machine-readable medium of claim 1, the operations further comprising:
determining, based on at least a subset of the computed influence scores, an influence-directed explanation why a given set of inputs to the deep neural network corresponds to the output quantity of interest,
wherein the output associated with the computed influence scores comprises the influence-directed explanation.

4. The machine-readable medium of claim 3, wherein the influence-directed explanation comprises a portion of the input responsible for the output quantity of interest.

5. The machine-readable medium of claim 3, the operations further comprising:
determining that, for the given set of inputs to the deep neural network, the output quantity of interest comprises an error; and
in response to the error and based on the influence-directed explanation, adjusting the deep neural network or providing additional training data or different preprocessing steps to the deep neural network.

6. The machine-readable medium of claim 1, the operations further comprising:
identifying, from the artificial neurons in the set of intermediate artificial neurons, a first subset of artificial neurons and a second subset of artificial neurons, wherein, for each artificial neuron in the first subset, the influence score exceeds a threshold value, and wherein, for each artificial neuron in the second subset, the influence score does not exceed the threshold value;
generating a new artificial neural network comprising the first subset of artificial neurons and lacking at least a portion of the second subset of artificial neurons; and
providing an output representing the new artificial neural network.

7. The machine-readable medium of claim 6, the operations further comprising:
using the new artificial neural network for inference to solve a same problem as the deep neural network.

8. The machine-readable medium of claim 6, wherein the new artificial neural network lacks each and every artificial neuron in the second subset of artificial neurons.

9. The machine-readable medium of claim 1, wherein:
the set of intermediate artificial neurons comprises an intermediate layer,
the input is x,
the output quantity of interest is y=f(x)=g(h(x)), and
the intermediate layer is z=h(x).

10. The machine-readable medium of claim 9, wherein computing the influence score for a given artificial neuron zj in the intermediate layer comprises computing:
$${{χ}_{j}^{s} ( f , P ) = {\int }_{χ} \frac{\partial g}{\partial {z}_{j}} \vert}_{h ( x )} P ( x ) dx$$
wherein:
χ is the influence score, and
P(x) is the probability of the input x.

11. A non-transitory machine-readable medium storing instructions which, when executed by one or more computing machines, cause the one or more computing machines to perform operations comprising:
accessing a set of intermediate artificial neurons in a deep neural network, wherein the deep neural network is fully or partially trained;
computing, for each artificial neuron in the set of intermediate artificial neurons, an influence score, wherein the influence score measures an influence of the artificial neuron on an output quantity of interest for a set of inputs of the deep neural network;
identifying, from the artificial neurons in the set of intermediate artificial neurons, a first subset of artificial neurons and a second subset of artificial neurons, wherein, for each artificial neuron in the first subset, the influence score exceeds a threshold value, and wherein, for each artificial neuron in the second subset, the influence score does not exceed the threshold value;
generating a new artificial neural network comprising the first subset of artificial neurons and lacking at least a portion of the second subset of artificial neurons; and
providing an output representing the new artificial neural network.

12. The non-transitory machine-readable medium of claim 11, the operations further comprising:
using the new artificial neural network for inference to solve a same problem as the deep neural network.

13. The machine-readable medium of claim 11, wherein the new artificial neural network lacks each and every artificial neuron in the second subset of artificial neurons.

14. The machine-readable medium of claim 11, wherein the influence score is computed based on an average gradient of the output quantity of interest with respect to the artificial neuron across the set of inputs weighted by a probability of each input.

15. The machine-readable medium of claim 11, the operations further comprising:
determining, based on at least a subset of the computed influence scores, an influence-directed explanation why a given set of inputs to the deep neural network corresponds to the output quantity of interest; and
providing an additional output representing the influence-directed explanation.

16. The machine-readable medium of claim 15, wherein the influence-directed explanation comprises a portion of the input responsible for the output quantity of interest.

17. A system comprising:
processing circuitry; and
a memory storing instructions which, when executed by the processing circuitry, cause the processing circuitry to perform operations comprising:
accessing a set of intermediate artificial neurons in a deep neural network, wherein the deep neural network is fully or partially trained;
computing, for each artificial neuron in the set of intermediate artificial neurons, an influence score based on an average gradient of an output quantity of interest with respect to the artificial neuron across a plurality of inputs weighted by a probability of each input; and
providing an output associated with the computed influence scores.

18. The system of claim 17, wherein the influence score measures an influence of the artificial neuron on the output quantity of interest for a set of inputs of the deep neural network.

19. The system of claim 17, the operations further comprising:
determining, based on at least a subset of the computed influence scores, an influence-directed explanation why a given set of inputs to the deep neural network corresponds to the output quantity of interest,
wherein the output associated with the computed influence scores comprises the influence-directed explanation.

20. The system of claim 19, wherein the influence-directed explanation comprises a portion of the input responsible for the output quantity of interest.

21. A method comprising:
accessing, at one or more computing machines, a set of intermediate artificial neurons in a deep neural network, wherein the deep neural network is fully or partially trained;
computing, for each artificial neuron in the set of intermediate artificial neurons, an influence score based on an average gradient of an output quantity of interest with respect to the artificial neuron across a plurality of inputs weighted by a probability of each input; and
providing an output associated with the computed influence scores.
